(19) United States
(12) Patent Application Publication
(10) Pub. No.: US 2018/0339809 A1
(43) Pub. Date: Nov. 29, 2018

(54) PORTABLE ARTICLE HOLDER

(71) Applicant: Eagle Holdings LLC, Portland, OR (US)

(72) Inventor: Vahan M. Dinihanian, JR., Portland, OR (US)

(73) Assignee: Eagle Holdings LLC, Portland, OR (US)

(21) Appl. No.: 15/796,801

(22) Filed: Oct. 29, 2017

Related U.S. Application Data
(63) Continuation-in-part of application No. 29/605,510, filed on May 26, 2017.

(51) Int. Cl. B65D 25/22; B65D 25/04; B65D 43/16; B65D 53/02; B65D 43/22; F16M 13/02

(52) U.S. Cl. CPC B65D 25/22; B65D 25/04; B65D 43/169; B25H 3/00; B65D 43/22; F16M 13/02; B65D 53/02

(57) ABSTRACT

Portable holder adapted for attachment to a larger device and for holding articles, comprising: an elongated tubular at least partially hollow case defining at least one interior cavity, the case having first and second ends and defining at least one opening into the interior cavity of the case; at least one repeatedly-openable moisture-resistant cover on and corresponding with the at least one opening for sealingly closing the opening to the interior cavity; either a permanently-fixed mounting bracket attached to the case, or alternatively a separate quick-release bracket, each adapted for interfacing the case with the larger device; a plurality of grooves defined in the case adapted for optionally receiving a corresponding plurality of elongated cinchable strap members for securing the case to the larger device.

### CROSS-REFERENCE TO RELATED APPLICATIONS

This patent application is a continuation in part of U.S. patent application Ser. No. 29/605,510, for PORTABLE SMALL ARTICLE HOLDER, filed 26 May 2017.

### FIELD OF THE INVENTION

This invention relates generally to portable article holders, and more particularly to a portable article holder, adapted for easy attachment to a larger device or machine, such as a durable medical device, a power tool, a cart, or a vehicle such as a car, a motorcycle, a scooter, a bicycle, a golf cart, a boat, or a personal watercraft, and having a plurality compartments adapted for holding articles such as keys, registration certificates, coins, tees, spark plugs, patch kits, or others.

### BACKGROUND OF INVENTION

There is a great need for persons to store, sometimes in an inconspicuous fashion, often smaller-sized, articles relating to a vehicle or larger device or machine they are using. Thus, for example, a dirt-bike motorcycle rider would need to have, and indeed probably should not leave home without, readily accessible items such as a registration document, an ATV-card, an extra spark plug, a chain link, perhaps a fuel filter, or a small multi-tool.

In the past, riders of different vehicles have kept such items, if he or she has remembered to bring them at all, in diverse locations such as pants pockets, under a motorcycle or personal watercraft seat, or in a back-pack. Therefore, when the rider has needed such articles to make a repair in the field, or to produce needed documentation to authorities, they have not been readily accessible, or they (for example a registration certificate) have become damaged by moisture or by sharing the same compartment with other items. Surprisingly, it has been learned that part of the reason users have failed to carry such smaller-sized articles with them as is important and necessary at times, has been because there has not been a suitable solution and location to carry them in a waterproof way and without just having thrown them in a larger container or pack along with other articles, thus making them hard to find when they have been needed.

Thus, there has developed a need for a smaller-sized portable article holder, preferably having a plurality of easily accessible, water-proof compartments, which is durable as well as securely fastenable sometimes in an inconspicuous way, and without excess motion on and relative to the larger device so as to not get in the way of use of the larger device or to distract the user from other important activities. Such a portable article holder preferably would be of a smaller profile so as to be out of the way, preferably would be possibly even inconspicuous if desired, would protect the carried articles from outside elements, water and moisture, and also would make the carried articles readily available when needed. Such a device would preferably have a hard exterior and would be very securely fastened to the larger device such that repeated bumping of the device, for example where installed on a gas-powered gardening tool thrown in the back of a truck, or upon being bumped by the rider of a motorcycle, etc., would not dislodge the article holder from its attachment to the larger device, and so that the article holder would remain closed and sealed.

There has also arisen a similar need for bicycle riders, who have needed to store identification, coins, a patch kit, a spare key, valve stem caps, a spoke wrench, a small multi-tool, tire changing tools, etc. Further, a similar need has arisen for golfers and their golf carts or golf bags to store golf tees, ball markers, divot repair tools, pencils, score cards, and the like, all without the need for the user to dig around in a larger compartment on a golf bag.

Still further, one can imagine the time and money savings that could be achieved by users of lawn equipment, such as lawnmowers and gas-powered blowers or weed trimmers, by being able to simply access a spare, or extra, spark plug stored on the lawn tool, so that a worker doesn't have to stop working operations for too long, for example to go back to the truck, or worse yet to make a trip to the part store to pick up a spark plug to replace a fouled spark plug.

Still further, a similar need has arisen, for persons who use durable medical equipment such as wheelchairs, walkers, and canes, to store emergency medical information on the particular durable medical device. Such information might include identification, medications taken, resuscitation instructions, medications needed, etc., stored securely but also marked with “EMERGENCY INFORMATION” and easily accessible for emergency responders.

In all of the foregoing situations, it would have been advantageous if there had been provided a durable container that would have been easily attachable to a bar, or other curved surface component on the larger device, and that would have been securely sealed, to allow convenient waterproof and secured carrying of needed smaller-sized articles so that these may have been readily made available to users right when the need had arisen.

There are known prior article holders, all of which have certain shortcomings relative to the aforementioned ideals, making them less than fully advantageous for storing needed smaller-sized articles and for attachment to a larger device, such as a durable medical device, a power tool, a cart, or a vehicle such as a car, a motorcycle, a scooter, a bicycle, a golf cart, a boat, or a personal watercraft.

Thus, for example, in U.S. Pat. No. 2,630,640 to Stevenson, for Article Holder, there is taught an envelope with provision to seal the envelope which also serves as a means to attach the article holder to the clothing of a person or suitable carrier or support. And while the article holder of Stevenson is said to have as an object of the invention that it is rain resistant, it is not described as being water-proof, for example if it were to be submerged in water. Further, the article holder of Stevenson is flat, as for perhaps carrying documents, so it would not handle well the carrying of both a document and a spark plug in the same carrier in such a way that the document would not become damaged by being carried in the same compartment as the spark plug. Further, there is no provision with Stevenson that the article holder would be secured against swinging around on the person or device to which it is to be attached. This could serve as a problem for the user of the Stevenson device on, say, a gas-powered motorized weed cutting tool, since such a loosely-attached carrier would tend to get in the way when the user moves the tool through the motions necessary to use the tool properly.

Similar to the Stevenson device, there are known pouches or bags for attachment to bicycles, for example, which are used for carrying smaller-sized articles under the seat of the bicycle, or a crossbar of the handlebars of the bicycle, for example as described in U.S. Pat. No. 4,852,778, to Beiser et al. Or alternatively, as described in U.S. Pat. No. 575,536 to Swanson, for Tourists Bicycle-Bag, a bag is provided to be stored between a head portion and braces portions of a bicycle frame. The bag of Beiser et al., for

Combination Bicycle Bag and Handbag, would swing around too much on the bike (or other device to which it might be attached), and while the system of attachment to the bicycle disclosed in Swanson solves the problem of the pouch or bag swinging around, since it is attached in three different locations, such would not be ideal for other devices where perhaps such angled braces have not been readily available for attachment of the storage device or holder. A further problem with the Swanson and Beiser et al. devices is that they have provided for one large compartment (albeit apparently divided into smaller compartments as shown in FIG. 5 of Swanson), which upon opening the hinged top to the compartment, the contents in the bag could all fall out onto the ground. Thus, it would be preferable if the compartments of Swanson and Beiser et al. were each independently accessible to prevent this problem.

Still further in relation to the desirability of individually-accessible compartments, there are known in the prior art zippered individually-accessible compartments, such as for currently available zippered bags attachable to the underside of a bicycle seat. However, such zippered bags have not provided for a smaller-profile, hard-case exterior, easily accessible flip-top, secure, waterproof, easily attachable/detachable, portable article holder, well-suited alternately for concealed or non-concealed attachment, to a single tubular frame of a larger device or machine. Often times such zippered bags are difficult to attach securely to the underside of a user's seat and in such a way that they don't swing excessively during riding.

The aforementioned devices, as well as the devices of Swanson, Beiser et al., and Stevenson, do not teach a device capable of quick-release attachment and detachment, are not described as waterproof, and the exterior structure of the Swanson device is quite bulky and easily detectible from the exterior of the bicycle to which it is attached. This would not be well-suited for storing such smaller-sized articles for a motorcycle or other vehicle, for example where a rider may wish to hide the portable article holder in an inconspicuous location that may not be all that easily accessible under a car hood to safeguard valuable contents. The Swanson device would be too bulky and thus would not be suitably inconspicuous for such use. Still further, since the Swanson device is so bulky it would not be as readily suitable for use in multiple embodiments on a single vehicle, whereas a smaller device could more readily advantageously be so used.

### SUMMARY OF THE INVENTION

In accordance with a first aspect of the invention, there is provided a portable article holder adapted for attachment to a larger device, comprising: an elongated at least partially hollow case defining at least one interior cavity, the case having first and second ends and defining at least one opening into the interior cavity of the case, and at least one repeatedly-openable moisture-resistant cover on and corresponding with the at least one opening of the case for sealingly closing the opening to the interior cavity. A mounting bracket is attached to the case and adapted for interfacing the case with a component on the larger device, and there is also provided means adapted for securing the case to the larger device with the mounting bracket interfacing between the case and the larger device.

Preferably, the opening to the case is defined at one of the first and second ends, and thus, preferably, the cover is a repeatedly-openable moisture-resistant and waterproof cap on one of the first and second ends of the case for accessing the interior cavity.

Further, preferably, the portable article holder's case further comprises a dividing wall within the interior cavity dividing the interior cavity into a plurality of compartments, wherein each of the first and second ends defines an opening to a different compartment than the other opening. Thus, preferably, there are provided a plurality of repeatedly-openable moisture-resistant caps, one on each of the first and second ends of the case, for accessing the different compartments. Still further, preferably, each of the compartments is of a different longitudinal length as measured along the length of the interior cavity of the case.

In accordance with another aspect of the invention, the portable article holder case is adapted for easy attachment, and in one embodiment simple non-deforming detachment, to the larger device, or a component (e.g., a tubular component) on the exterior of the larger device, such as a durable medical device, a power tool, a cart, or a vehicle such as a car, a motorcycle, a scooter, a bicycle, a golf cart, a boat, or a personal watercraft. Preferably at least one of the compartments in accordance with this aspect of the invention is large enough so as to be adapted for holding a registration document apart from an article (such as a master chain link) in a separate compartment.

Preferably, in accordance with another aspect of the invention, the plurality of caps of the portable article holder are thumb-operable, or finger-operable flip-top type caps, and each end defining an opening in the case comprises an o-ring type seal integrated at the opening to allow sealing of the cap on the opening. In this way, moisture is prevented from getting into the cavity in order to protect its contents from being damaged. This may be important for documents, electronic components, and the other water sensitive articles.

Preferably, in accordance with an aspect and embodiment of the invention, the means adapted for securing the case of the portable article holder to a larger device comprises a plurality of grooves defined around a portion of an exterior periphery of the case. Further, these grooves are adapted for receiving and retaining (from sliding up or down longitudinally along the length of the case), a plurality of elongated flexible tightenable straps, one strap for each groove and adapted for wrapping around the exterior of the case and at least a portion of the larger device. These elongated flexible tightenable straps are commonly known as zip ties, they are user operable for cinching down to tighten and securely interconnect the case on the larger device, and this aspect of the invention may be considered as not including the zip ties (i.e., in accordance with this aspect of the invention the case is adapted for being secured to the larger device), or alternatively, the zip ties may be included as part of the invention.

Since many devices to which the portable article holder of the various aspects and embodiments of the invention may be attached comprise tubular components, such as walkers, wheelchairs, lawn mowers, weed eaters, motorcycles, bicycles, golf carts, and the like, in an embodiment in accordance with another aspect of the invention, the larger device comprises a tubular member on the larger device, and the mounting bracket attached to the case of the portable article holder preferably comprises an elongated concave outer-surface mounting bracket attached to the case and adapted for interfacing the case with the tubular member of the larger device. In accordance with this aspect and embodiment of the invention, like previously-described aspects and embodiments of the invention where the portable article holder may be adapted for attachment to a non-tubular component of the larger device, the means adapted for securing the case to the larger device comprises a plurality of grooves defined around a portion of an exterior periphery of the case and adapted for retaining a plurality of elongated flexible tightenable straps (i.e., zip ties), one strap for each groove and adapted for wrapping around the exterior of the case and at least a portion, such as a tubular portion, of the larger device, the zip ties being user operable for cinching down to tighten the case on the larger device.

In accordance with an alternative embodiment of the invention, the means for securing the case of the portable article holder to a larger device comprises a quick-release adapter comprising a separate bracket further comprising flexible wings or fingers extending from a base adapted for mounting, as with screws, to the larger device. In accordance with this embodiment of the invention, the flexible wings are conforming for press-fit releasable conformance to corresponding outer contours of the case for releasably holding the case onto the larger device.

Thus, if the case is cylindrical, or tubular, case for the portable article holder, the wings of the quick-release adapter would comprise a concave cylindrical surface adapted for conforming to and holding the outer cylindrical surface of the case. Preferably, the wings could have keyed sides for snapping into place around the sides of either a cylindrical or a rectangular case. Further, the base for this alternative embodiment of the invention would preferably comprise a keyway channel in which the bracket portion of the portable article holder case resides when the case is attached to the alternate base. This structure prevents a cylindrical case from rotating in the flexible wings of the alternative bracket and further solidifies the structure of the interconnection between the case and the larger device to which the case is to be attached.

Preferably, in accordance with another aspect of the invention, for cost reasons and for simplicity of manufacture, the case, the mounting bracket, and the caps of the portable article holder are all injection molded as a singular plastic component, that is of a relatively hard durometer plastic for thicker-walled portions of the portable article holder, but not too hard or brittle of a durometer of plastic so as to prevent flexibility of a hinge portion between the caps and the case. Thus, in accordance with this aspect of the invention, each cap is preferably hinged to the case with a unitary living-type hinge of plastic material bridging an edge of the cap and the case adjacent the opening to the case. Further, in accordance with this aspect of the invention, each cap preferably comprises a unitary molded flexible finger-operable latching member at each end of the case adapted for reinforcing closure of each the cap on its respective end of the case.

Thus, in accordance with one or more aspects and an embodiment of the invention, there is provided a portable article holder adapted for attachment preferably to a tubular member of a larger device, comprising an elongated tubular at least partially hollow case defining at least one interior cavity, the case having first and second ends and defining at least one opening into the interior cavity of the case. There is provided on the case at least one repeatedly-openable moisture-resistant cover on and corresponding with the at least one opening for sealingly closing the opening to the interior cavity. Further, there is provided an elongated preferably concave outer surface mounting bracket attached to the case and adapted for interfacing the case with the tubular member of the larger device.

As with previously described embodiments of the invention, this embodiment further comprises means adapted for securing the case to the tubular member on the larger device, which means either comprises a plurality of grooves defined in the exterior of the case adapted for receiving and retaining zip ties for tying the case to the frame of a larger device, or a quick-release adapter with a base for attachment (as with screws) and flexible winged, and preferably keyed, fingers for retaining the case in place.

Also, as with other aspects and embodiments previously described, this embodiment of the invention preferably comprises repeatedly-openable moisture-resistant caps on one, or both of the first and second ends of the case, the case also optionally being provided with a single interior cavity or a plurality of interior cavities, or compartments, each of the same size, or alternatively of different sizes and longitudinal lengths.

Further, as with other aspects of the invention, the portable article holder of this embodiment of the invention is preferably provided with flip-top type caps, wherein each end defining an opening of the case also comprises an o-ring type seal integrated at the opening to allow sealing of the cap on the opening.

In accordance with an aspect and embodiment of the invention, there is provided a unitary plastic portable article holder adapted for attachment via elongated cinchable straps to a tubular member of a larger device, comprising: an elongated tubular at least partially hollow case defining a plurality of separate divided longitudinally-extending interior cavity compartments, the case having first and second ends, each end having an integral o-ring seal thereon and defining an opening for accessing one of the interior cavity compartments.

Further, there is provided with this embodiment of the invention a plurality of repeatedly-openable moisture-resistant flip-top type caps, each cap hinged to the case with a unitary living-type hinge, one cap on, and corresponding with each of, the first and second ends of the case for sealingly closing the openings to the separate interior cavity compartments.

Further, preferably with this embodiment of the invention, there are provided a plurality of finger-operable flexible latches, one latch corresponding for each flip-top type cap and for securing each flip-top type cap against opening on impact or other contact with other items. A mounting bracket for this embodiment of the invention comprises an elongated concave outer-surface mounting bracket attached to the case and adapted for interfacing with the tubular member of the larger device to which the bracket is to interface. And, preferably, there are provided a plurality of grooves defined around a portion of an exterior periphery of the case each adapted for receiving a plurality of elongated flexible tightenable straps, one strap for each groove, adapted for wrapping around the exterior of the case and the tubular component on the larger device, each strap being user operable for cinching down to tighten the case on the tubular component.

In accordance with another aspect of the invention, there is provided a multi-use, multi-location, easily-accessible, hard-case (rigid-case), portable article storage, or carrying, system comprising a readily-removable and re-installable, portable article holder easily mounted on a rod, pole, or other discreet item with straps or zip ties, or to an even larger curved, or optionally flat, surface. This aspect of the invention comprises an independently mountable quick-release bracket able to be mounted to a larger surface, either a curved-surface, or optionally a flat-surface. The portable holder of this aspect of the invention is preferably also keyed, in that the bracket of a previously-described aspect of a portable article holder preferably fits into a rectangular slot in the bracket to keep the holder from being easily rotatable within the bracket, thus lending to the solidarity of the holder/bracket combination.

The quick-release bracket of this aspect of the invention comprises a slip-fit-force-fit-type bracket having wings, or fingers, that can be spread apart to accept the hard case of the portable article holder, much as a flexi-mount type bracket's wings may be spread apart in order to receive a corresponding portable article holder. The quick-release bracket of this aspect of the invention is keyed in the sense that there are preferably provided protrusions on each wing, or finger, adapted for fitting into grooves on the surface of the portable article holder. This keying prevents the portable article holder from sliding up and down longitudinally within the quick-release bracket, whereas the rectangular slot in the bracket is adapted also to receive the rectangular bracket on the portable article holder as well in order to prevent rotational movement of the portable article holder within the quick-release bracket. The quick-release bracket may be screwed in or surface mounted with glue (or double-sided tape) to a flat or curved surface and thus adapted for receiving and holding a portable article holder on such a surface.

The portable article holder of this aspect of the invention is multi-location in that the bracket may be installed on virtually any curved or flat surface, and it is thus more easily accessible, since the portable holder may be easily removed from the quick-release bracket in order to easily pour contents out of either end of the holder. As such, the portable article holder/bracket combination of this aspect of the invention would be adaptable for secure (non-swinging and immobilized but readily-removable) use on many different kinds of surfaces.

The device in accordance with this aspect of the invention makes the portable article holder more accessible, in that it may be more easily used as a pill holder or hiding place for a key, where the user is supported in repeatedly reaching to an even non-conspicuous location (for example reaching down into the engine mount area under the hood of a car) for removing the holder, pouring the contents out, using the contents, putting the remaining contents back in the holder again (for example, as one would do when pouring out diverse vitamins, or diverse small articles such as screws, nuts and bolts, and selecting only the desired items), and reattaching the holder on its keyed base, all without having to reattach the base, but only the holder, to the base.

The subject matter of the present invention is particularly pointed out and distinctly claimed in the concluding portion of this specification. However, both the organization and method of operation, together with further advantages and objects thereof, may best be understood by reference to the following descriptions taken in connection with accompanying drawings wherein like reference characters refer to like elements.

### BRIEF DESCRIPTION OF THE DRAWINGS

FIG. 1 is a rear perspective view of an embodiment of a portable article holder in accordance with one or more aspects of the invention;

FIG. 2 is rear perspective view of the portable article holder of FIG. 1 with the caps thereof shown in open position;

FIG. 3 is a rear view of an alternative embodiment portable article holder in accordance with one or more aspects of the invention;

FIG. 4 is a front view of an alternative embodiment portable article holder in accordance with one or more aspects of the invention;

FIG. 5 is a right side view of an alternative embodiment portable article holder in accordance with one or more aspects of the invention;

FIG. 6 is a left side view of an alternative embodiment portable article holder in accordance with one or more aspects of the invention;

FIG. 7A is a top plan view of an embodiment of a closed-cap portable article holder in accordance with one or more aspects of the invention;

FIG. 7B is a top plan view of an alternate embodiment of an open-cap portable article holder in accordance with one or more aspects of the invention;

FIG. 8 is a right side view illustration of an embodiment of a portable article holder attached to a tubular member portion of a larger device in accordance with one or more aspects of the invention;

FIG. 9 is a rear perspective view of a combination portable article holder and quick-release bracket for the same in accordance with another aspect of the invention; and

FIG. 10 is an end view of an alternate quick-release bracket for a portable article holder in accordance with an aspect of the invention.

### DETAILED DESCRIPTION OF THE INVENTION

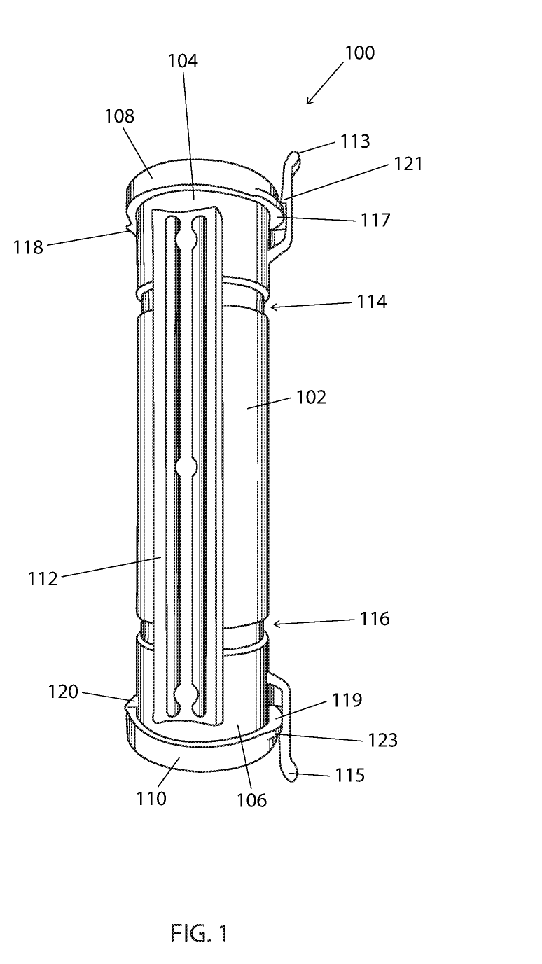

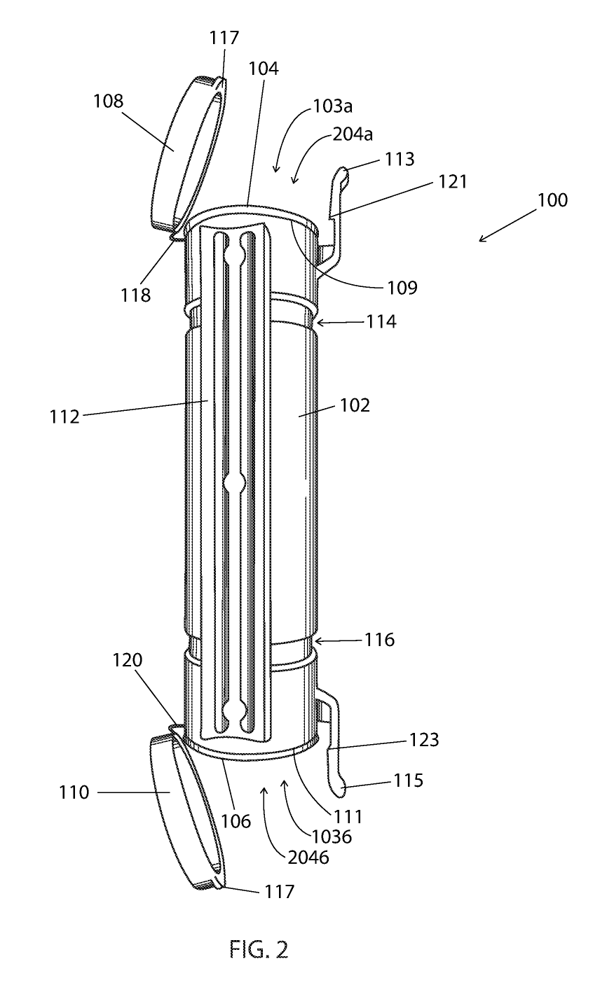

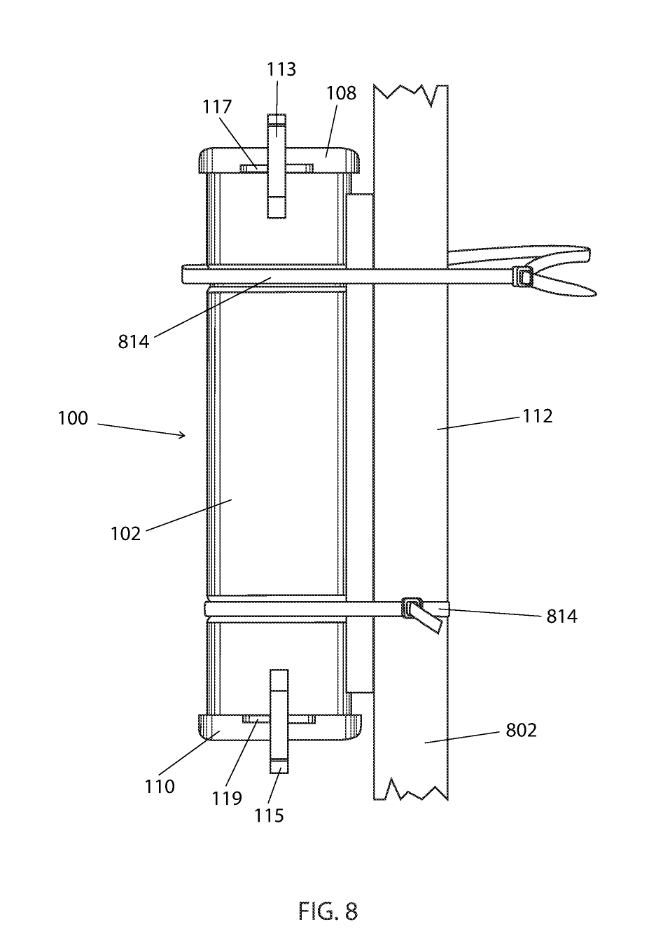

Referring to FIGS. 1, 2 and 7A, in accordance with an aspect and embodiment of the invention, there is provided a portable article holder 100 adapted for attachment to a larger device 802 (as shown in FIG. 8), such as a tubular member of a durable medical device, a power tool, a cart, or a vehicle such as a car, a motorcycle, a scooter, a bicycle, a golf cart, a boat, or a personal watercraft. The holder 100 comprises an elongated, at least partially hollow, case 102 defining a plurality of interior cavities 103a, 103b, the case having first and second ends 104, 106, respectively, and defines a plurality of openings 204a, 204b into the interior cavities of the case. Each opening 204a, 204b of the case 102 has corresponding therewith, a repeatedly-openable moisture-resistant cover or cap 108, 110 for sealingly closing the opening to the cavities 103a, 103b. Each cap 108, 110 is preferably attached to a corresponding end 104, 106, respectively, of the case 102 with a living hinge extending between a peripheral portion of each cap and adjacent each corresponding end of the case. A living hinge is essentially an interconnecting piece of injection molded plastic that is pre-stressed so as to be functional for many thousands of repeated opening and closing movements before failing.

A mounting bracket 112 is attached to the case 102 and adapted for interfacing the case with the component or member 802 on the larger device. There is also provided means comprising grooves 114, 116 and a corresponding plurality of elongated straps 814 (of FIG. 8) adapted for securing the case 102 to the component 802 of the larger device with the mounting bracket 112 interfacing between the case and the larger device.

The plurality of grooves 114, 116 are preferably defined at somewhat centralized positions on the case 102 a distance from the ends 104, 106 of the case, the grooves extending substantially around an exterior periphery of the case. Further, these grooves 114, 116 are adapted for receiving and retaining (from sliding up or down longitudinally along the length of the case 102), the corresponding plurality of elongated flexible tightenable straps 814, one strap for each groove and adapted for wrapping around the exterior of the case and at least a portion, or component 802, of the larger device. These elongated flexible tightenable straps 814 are commonly known as zip ties, they are user operable for cinching down to tighten and securely interconnect the case 102 on the larger device 802, and this aspect of the invention may be considered as not including the zip ties (i.e., in accordance with this aspect of the invention the case is adapted for being secured to the larger device, or alternatively, the zip ties may be included as part of the invention).

These elongated flexible tightenable straps 814 may comprise commonly-known zip ties which are user operable for cinching down to tighten and securely interconnect the case 102 on the component 802 of the larger device. A product in accordance with one or more aspects of the invention may either include zip ties, or may simply be adapted for attachment if desired by a user. In other words, while the case 102 of the portable article holder may be adapted for attachment to a larger device, it need not be so attached, but rather it may alternatively be carried in a glove compartment, or in another accessible compartment, on a vehicle such as under the seat of a motorcycle for example.

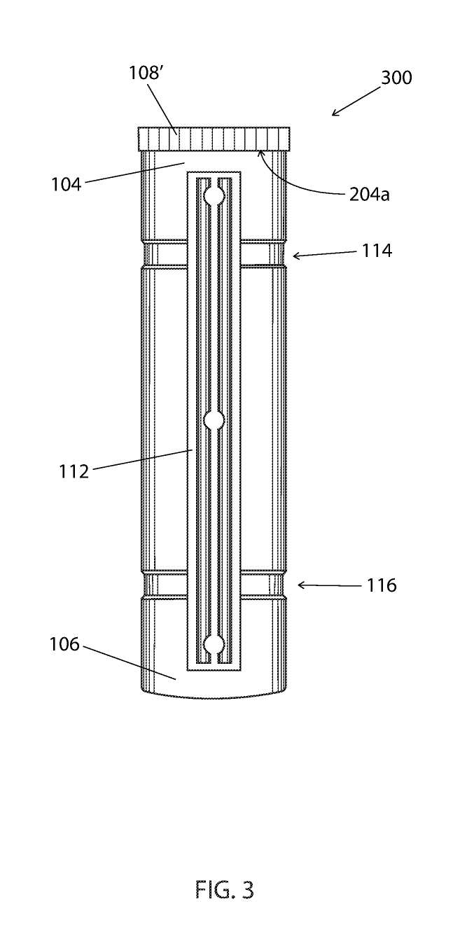

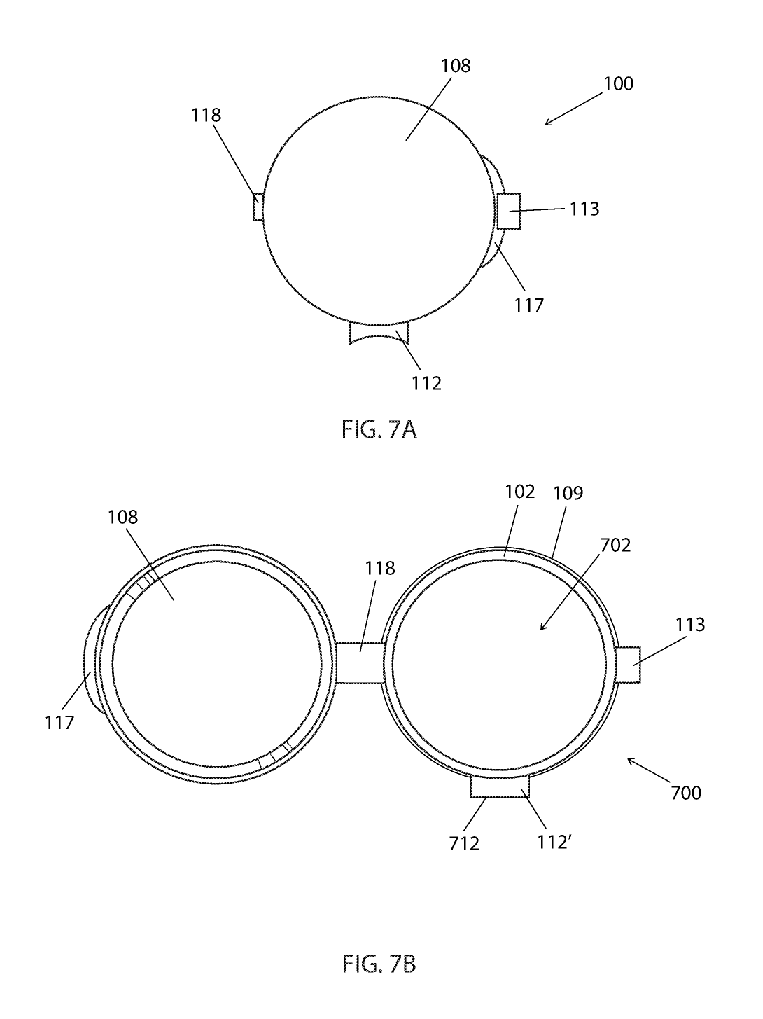

Preferably, the openings 204a, 204b are defined at the corresponding first and second ends 104, 106 of the case, respectively. Thus, preferably, the caps 108, 110, which are repeatedly-openable moisture-resistant caps, are located adjacent and are preferably attached via living hinges 118, 120 on the corresponding first and second ends 104, 106 of the case 102. These caps 108, 110 are for allowing accessing of the interior cavities 103a, 103b (or cavity in the case of the embodiment of FIG. 3 or FIG. 7B further described below).

Preferably there is provided a finger-, or thumb-operable, flexible latch 113, 115 for latching closed each cap 108, 110, respectively, and for reinforcing in place each cap on its respective end 104, 106 of the case 102. Each latch has a hooking notch 121, 123 for hooking and latching the latch on a respective lip 117, 119 on each cap 108, 110 to hold the cap in a closed position despite jarring or bumping of the case 102. To operate the latch, a user simply pulls the latch 113, 115 outwardly away from the case 102 to disengage the hooking notch 121, 123 from its respective lip 117, 119 on respective caps 108, 110.

Each of the plurality of caps 108, 110 of the portable article holder 100 is a flip-top type caps, wherein a user can flip the cap open with his or her finger or thumb pushing outwardly on the lip 117, 119, respectively, of each cap in order to open the cap. Under an overlapping portion of each cap 108, 110, at each end 104, 106 defining an opening 204a, 204b in the case 102, there is provided an o-ring type seal 109, 111, respectively, integrated at the opening to allow sealing of the cap on each respective opening. In this way, moisture is prevented from getting into the cavities 103a, 103b in order to protect the contents of the portable article holder 100 from being damaged. This may be important for documents, electronic components, and the other water sensitive articles.

Referring to FIG. 3, there is provided an alternative embodiment of a portable article holder 300 in accordance with one or more aspects of the invention. The portable article holder 300 is similar to the portable article holder 100, in that it comprises first and second ends 104, 106, a bracket 112, and means (e.g., grooves 114, 116) for allowing attachment of the portable article holder 300 to a larger device, or component 802 thereof, with a plurality of straps 814. However, unlike portable article holder 100, portable article holder 300 does not have a plurality of thumb-operable-flip-top-type caps 108, 110, but rather a single screw on, and off, cap 108′ for allowing sealable access to the cavity, or cavities 103a, 103b of the portable article holder.

Thus, the portable article holder 100 is provided with a plurality of openings 204a, 204b and corresponding cavities 103a, 103b, whereas portable article holder 300 is provided with one cavity (e.g., see cavity 702 of FIG. 7), and a corresponding opening 204a. The cavity(ies) 702, 103a, 103b of the portable article holder 100, 300 are designed to be moisture proof so that the contents (e.g., such as registration documents, a spark plug, a small electronic device, etc.) contained in the portable article holder will not be damaged by submersion or otherwise wetting of the holder. This is particularly important so that important documents, or perhaps electronic storage items, won't be damaged by moisture while contained in the portable article holder 100, 300.

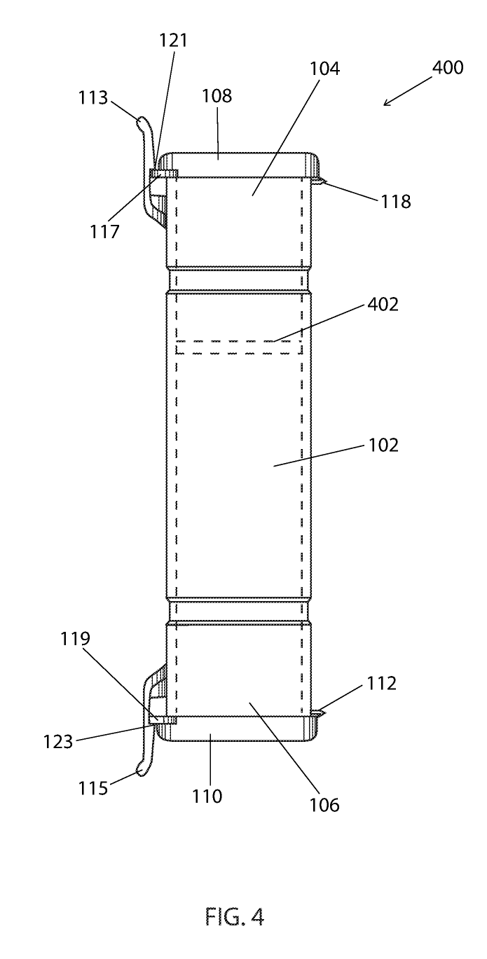

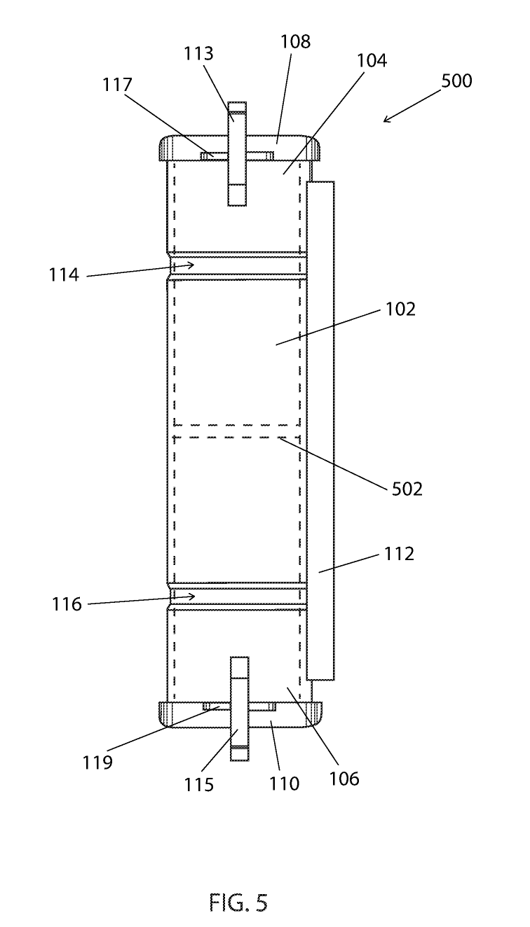

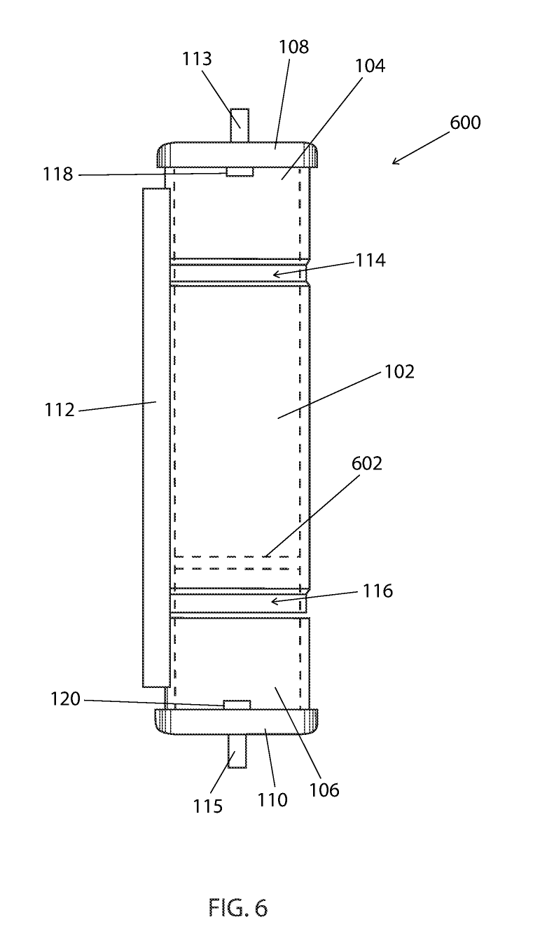

Referring to FIGS. 4-6, further, in accordance with an aspect and three different embodiments of the invention, preferably, the case 102 of each portable article holder 400, 500, 600 case comprises a dividing wall 402, 502, 602, respectively, within the case 102 to form each interior cavity 103a, 103b, dividing the interior cavity into a plurality of compartments. Like the portable article holder 100, each of portable article holders 400, 500, 600 each comprise first and second ends 104, 106, wherein each of the first and second ends defines an opening to a different compartment than the other opening. Thus, preferably, there are provided a plurality of repeatedly-openable moisture-resistant caps 108, 110, one on each of the first and second ends 104, 106 of the case 102, for accessing the different compartments. Still further, preferably, either each of the compartments 103a, 103b is of a different longitudinal length as measured along the length of the interior cavity 103a, 103b of the case 102 (as shown in dotted lines in FIGS. 4 and 6), or alternatively, each of the compartments are of equal size (as shown in dotted lines in FIG. 5).

Referring now to FIG. 7B, there is shown an alternate embodiment of a portable article holder 700. Portable article holder 700 is similar to portable article holder 100, since both have a cap 108 attached to a case 102 with a living hinge 118, which latch is secured with a thumb-operable latch 113 to reveal at least one internal cavity (702), and since both have at least one o-ring seal 109.

As shown additional in FIG. 8, the multi-compartment portable article holder 100 (as well as portable article holder 400, 500, 600) of one or more aspects of the invention described herein, is adapted for attachment to a tubular component 802 on the exterior of a larger device, such as a durable medical device, a power tool, a cart, or a vehicle such as a car, a motorcycle, a scooter, a bicycle, a golf cart, a boat, or a personal watercraft, and wherein at least one of the compartments of the portable article holder is large enough so as to be adapted for holding a registration document apart from an article in a separate compartment. However, unlike these portable article holders 100, 400, 500, 600, the portable article holder 700 of FIG. 7 has a bracket 112′ which has a flat outer surface 712 adapted for interfacing with a correspondingly flat surface of a larger object to which the article holder is to be attached.

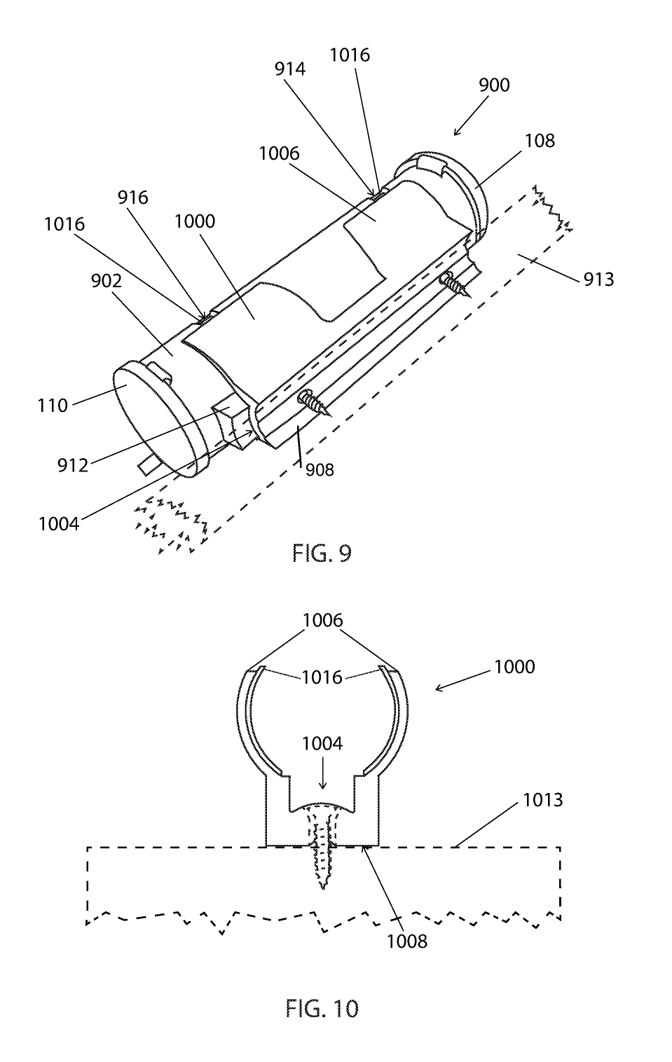

Referring now to FIGS. 9 and 10, there is provided a combination portable article holder 900 and quick-release bracket 1000 in accordance with an aspect of the invention. The combination portable article holder 900 and quick-release bracket 1000 comprises a multi-use, multi-location, easily-accessible, hard-case (rigid-case), portable article storage, or carrying, system comprising a readily-removable and re-installable, portable article holder 900 easily mounted on a rod, pole, or other discreet item with straps or zip ties, or to an even larger curved surface 913, or optionally a flat surface 1013. This aspect of the invention comprises an independently mountable quick-release bracket 1000 able to be mounted to such a larger surface 913, 1013.

The portable holder 900 of this aspect of the invention is preferably the same as other article holders 100, 300, 400, 500, 600, 700, described herein, each comprising a bracket portion 112. In accordance with this aspect of the invention, the bracket portion 112 essentially comprises a key, in that the bracket of the article holder preferably fits into a rectangular slot 1004 in the bracket to keep the holder 900 from being easily rotatable within the bracket, thus lending to the solidarity of the holder/bracket combination.

The quick-release bracket 1000 of this aspect of the invention comprises a slip-fit-force-fit-type bracket having flexible wings 1006, or fingers, that can be spread apart to accept the hard case 902 of the portable article holder 900, much as a flexi-mount type bracket's wings may be spread apart in order to receive a corresponding portable article holder. The quick-release bracket 1000 alternatively has either a curved outer surface 908 for interfacing with a curved larger device 913, or a flat outer surface 1008 for interfacing with a flat larger surface 1013.

In either case, whether with a curved outer surface 908, or a flat outer surface 1008, the quick-release bracket 900, 1000, respectively, may be screwed in, otherwise attached, or surface mounted with glue (or double-sided tape) to a correspondingly flat or curved surface and thus adapted for receiving and holding a portable article holder on such a surface.

The portable article holder 900 of this aspect of the invention is multi-location in that the bracket may be installed on virtually any curved surface 913 or flat surface 1013, and it is thus more easily accessible, since the portable holder may be easily removed from the quick-release bracket in order to easily pour contents out of either end of the holder. As such, the portable article holder 900/bracket 1000 combination of this aspect of the invention would be adaptable for secure (non-swinging and immobilized but readily-removable) use on many different kinds of surfaces.

The device in accordance with this aspect of the invention makes the portable article holder 900 more accessible, in that it may be more easily used as a pill holder or hiding place for a key, where the user is supported in repeatedly reaching to an even non-conspicuous location (for example reaching down into the engine mount area under the hood of a car) for removing the holder, pouring the contents out, using the contents, putting the remaining contents back in the holder again (for example, as one would do when pouring out diverse vitamins, or diverse small articles such as screws, nuts and bolts, and selecting only the desired items), and reattaching the holder on its keyed base 1000, all without having to reattach the base, but only the holder, to the base.

In accordance with this embodiment of the portable article holder 900, the flexible wings 1006 of the quick-release bracket 1000 are conforming for press-fit releasable conformance to corresponding outer contours of the case 902 for releasably holding the case onto the larger device 913, 1013.

Thus, if the case 902 is cylindrical, or tubular, the wings 1006 would comprise a concave cylindrical surface adapted for conforming to and holding the outer cylindrical surface of the case. As will be apparent to those of ordinary skill in the art, the wings may be rectangular and conform to a corresponding rectangular case, without departing from the scope and spirit of the invention. Also, each of the wings 1006 preferably have keyed protrusions 1016 for residing in the grooves 914, 916 of the case 902 (whether the case and wing combination is cylindrical, rectangular, or some other shape).

Thus, preferably, the quick-release bracket 1000 of this aspect of the invention is keyed 1016 in the sense that there are preferably provided curved, partially circumferential, keys, or protruding curved keys 1016, on each wing, or finger, 1006 adapted for fitting into the grooves 914, 916 on the surface of the case 902 of the portable article holder 900. These keys 1016 prevent the portable article holder 900 from sliding up and down longitudinally within the quick-release bracket 1000, whereas the rectangular slot 1004 in the quick-release bracket is adapted also to receive the rectangular bracket 912 on the portable article holder as well in order to prevent rotational movement of the portable article holder within the quick-release bracket.

Further, the base 912 (i.e., the bracket 912 permanently attached to the portable article holder 900 which is the same as that, bracket 112, attached to portable article holder 100) for this alternative aspect and embodiment of the invention essentially comprises a key for fitting securely into the keyway slot 1004 of the quick-release bracket 1000 when the case is attached to the quick-release bracket. This structure prevents a cylindrical case from rotating in the flexible wings of the alternative bracket and further solidifies the structure of the interconnection between the case and the larger device to which the case is to be attached.

Preferably, in accordance with another aspect of the invention, for cost reasons and for simplicity of manufacture, the case 102, the mounting bracket 112, and the caps 108, 110 of the portable article holder 100 (and other portable article holders described herein) are all injection molded as a singular plastic component, that is of a relatively hard durometer plastic for thicker-walled portions of the portable article holder, but not too hard or brittle of a durometer of plastic so as to prevent flexibility of thinner living hinge portions 118, 120 between the caps and the case.

While a preferred embodiment of the present invention has been shown and described, it will be apparent to those skilled in the art that many changes and modifications may be made without departing from the invention in its broader aspects. For example, it will be appreciated that one of ordinary skill in the art may mix and match the various components of the various embodiments of the invention without departing from the true spirit of the invention as claimed. Thus, it will be appreciated that any of the aforementioned aspects of the invention may be mixed to accommodate a particular embodiment. For example, a non-concave bracket member may be implemented for ready installation on a non-tubular portion of a larger device, or a concave bracket member may be implemented for ready installation on a tubular portion of a larger device. Or, alternatively, a screw-on type cap, or an intermediate covering for an intermediate opening on the case, may be implemented without departing from one or more aspects of the invention as claimed. Also, it will be appreciated from the foregoing disclosure that any portable article holder 100, 300, 400, 500, 600 may be used with a quick-release bracket 1000, and other shapes and sizes of quick-release brackets may be adapted to fit other larger devices or environments. The appended claims are therefore intended to cover all such changes and modifications as fall within the true spirit and scope of the invention.

I claim:

1. A portable article holder adapted for attachment to a larger device, comprising:
an elongated at least partially hollow case defining at least one interior cavity, said case having first and second ends and defining at least one opening into the interior cavity of said case;
at least one repeatedly-openable moisture-resistant cover on and corresponding with the at least one opening of said case for sealingly closing the opening to the interior cavity;
a mounting bracket attached to said case and adapted for interfacing said case with a component on the larger device; and
means adapted for securing the case to the larger device with the mounting bracket interfacing between the case and the larger device.

2. The portable article holder of claim 1, wherein the at least one opening is defined at one of the first and second ends, and wherein the cover is a repeatedly-openable moisture-resistant cap on one of the first and second ends of said case for accessing the interior cavity.

3. The portable article holder of claim 2, further comprising a dividing wall within the interior cavity dividing the interior cavity into a plurality of compartments, wherein each of the first and second ends defines an opening to a different compartment than the other opening, and wherein there is a repeatedly-openable moisture-resistant cap on each of the first and second ends of said case for accessing the different compartments.

4. The portable article holder of claim 3, wherein each compartment is of a different longitudinal length as measured along the length of the interior cavity of said case.

5. The portable article holder of claim 3, wherein said case is adapted for attachment to a tubular component on the exterior of the larger device, and wherein at least one of the compartments is large enough so as to be adapted for holding a registration document apart from an article in a separate compartment.

6. The portable article holder of claim 3, wherein each cap is a flip-top type cap, and wherein each end defining an opening comprises an o-ring type seal integrated at the opening to allow sealing of said cap on said opening.

7. The portable article holder of claim 3, wherein the means adapted for securing the case to a larger device comprises a plurality of grooves defined around a portion of an exterior periphery of said case and adapted for retaining a plurality of elongated flexible tightenable straps, one strap for each groove and adapted for wrapping around the exterior of said case and at least a portion of the larger device and user operable for cinching down to tighten said case on the larger device.

8. The portable article holder of claim 7, further comprising a plurality of elongated flexible tightenable straps, one strap for each groove and adapted for wrapping around the exterior of said case and at least a portion of the larger device and user operable for cinching down to tighten said case on the larger device.

9. The portable article holder of claim 7, wherein the larger device comprises a tubular member on the larger device, wherein the mounting bracket attached to said case comprises an elongated concave outer-surface mounting bracket attached to said case and adapted for interfacing said case with the tubular member of the larger device, and wherein the means adapted for securing the case to the larger device comprises a plurality of grooves defined around a portion of an exterior periphery of said case and adapted for retaining a plurality of elongated flexible tightenable straps, one strap for each groove and adapted for wrapping around the exterior of said case and at least a portion of the larger device and user operable for cinching down to tighten said case on the larger device.

10. The portable article holder of claim 1, wherein the means for securing the case to a larger device comprises a separate bracket further comprising flexible wings extending from a base adapted for mounting as with screws to the larger device, wherein the flexible wings are conforming for press-fit releasable conformance to corresponding outer contours of said case for releasably holding said case onto the larger device.

11. The portable article holder of claim 7, wherein said case, said mounting bracket, and said caps are all injection molded as a singular plastic component wherein each said cap is hinged to said case with a unitary living-type hinge, and further comprising a unitary molded flexible finger-operable latching member at each end of said case adapted for reinforcing closure of each said cap on its respective end of said case.

12. A portable article holder adapted for attachment to a tubular member of a larger device, comprising:
an elongated tubular at least partially hollow case defining at least one interior cavity, said case having first and second ends and defining at least one opening into the interior cavity of said case;
at least one repeatedly-openable moisture-resistant cover on and corresponding with the at least one opening for sealingly closing the opening to the interior cavity;
an elongated concave outer surface mounting bracket attached to said case and adapted for interfacing said case with the tubular member of the larger device; and
means adapted for securing the case to the tubular member on the larger device.

13. The portable article holder of claim 12, wherein the at least one opening is defined at one of the first and second ends, and wherein the cover is a repeatedly-openable moisture-resistant cap on one of the first and second ends of said case for accessing the interior cavity.

14. The portable article holder of claim 13, further comprising a lateral dividing wall within the interior cavity dividing the interior cavity into a plurality of compartments, wherein each of the first and second ends defines an opening to a different compartment than the other opening, and wherein there is a repeatedly-openable moisture-resistant cap on each of the first and second ends of said case for accessing the different compartments.

15. The portable article holder of claim 14, wherein each compartment is of a different longitudinal length as measured along the length of the interior cavity of said case, and wherein at least one of the compartments is large enough so as to be adapted for holding a registration document apart from an article in a separate compartment.

16. The portable article holder of claim 13, wherein each cap is a flip-top type cap, and wherein each end defining an opening comprises an o-ring type seal integrated at the opening to allow sealing of said cap on said opening.

17. The portable article holder of claim 12, wherein the means for securing the case to the tubular member of the larger device comprises a plurality of grooves defined around a portion of an exterior periphery of said case and adapted for retaining a plurality of elongated flexible tightenable straps, one strap for each groove and adapted for wrapping around the exterior of said case and the tubular member on the larger device and user operable for cinching down to tighten said case on the tubular member, said concave outer surface bracket interfacing between the tubular member and said case.

18. The portable article holder of claim 12, wherein the means for securing the case to a tubular member of a larger device comprises a separate bracket further comprising flexible wings extending from a base adapted for mounting as with screws to one of a tubular member and a flat surface of the larger device, wherein the flexible wings are conforming for press-fit releasable conformance to corresponding outer contours of said case for releasably holding said case onto the larger device.

19. A unitary plastic portable article holder adapted for attachment via elongated cinchable straps to a tubular member of a larger device, comprising:
an elongated tubular at least partially hollow case defining a plurality of separate divided longitudinally-extending interior cavity compartments, said case having first and second ends each having an integral o-ring seal thereon and defining an opening for accessing one of said interior cavity compartments;
a plurality of repeatedly-openable moisture-resistant flip-top type caps, each cap hinged to said case with a unitary living-type hinge, one cap on and corresponding with each of the first and second ends of said case for sealingly closing the openings to the separate interior cavity compartments;
a plurality of finger-operable flexible latches, one said latch corresponding for each flip-top type cap and for securing each flip-top type cap;
an elongated concave outer-surface mounting bracket attached to said case and adapted for interfacing with the tubular member of the larger device; and
a plurality of grooves defined around a portion of an exterior periphery of said case each adapted for receiving a plurality of elongated flexible tightenable straps, one strap for each groove and adapted for wrapping around the exterior of said case and the tubular component on the larger device and user operable for cinching down to tighten said case on the tubular component.

20. The portable holder of claim 19, further comprising a plurality of elongated flexible tightenable straps, one strap for each groove and adapted for wrapping around the exterior of said case and the tubular component on the larger device and user operable for cinching down to tighten said case on the tubular component.
